(19) United States
(12) Patent Application Publication
(10) Pub. No.: US 2023/0169606 A1
(43) Pub. Date: Jun. 1, 2023

(54) SYSTEMS AND METHODS FOR DATA AGGREGATION AND POST PROCESSING USING MICROSERVICES

(71) Applicant: JPMORGAN CHASE BANK, N.A., New York, NY (US)

(72) Inventors: Alan WATSON, London (GB); Maciej LOZICZONEK, London (GB); Sergei LEWIS, Cambridge (GB); Mikolaj SIELUZYCKI, Union City, NJ (US)

(21) Appl. No.: 17/457,211

(22) Filed: Dec. 1, 2021

(51) Int. Cl. G06Q 40/00; G06F 16/23

(52) U.S. Cl. CPC G06Q 40/12; G06F 16/2393; G06F 16/2358

(57) ABSTRACT

Systems and methods for data aggregation and post processing using microservices are disclosed. In accordance with embodiments, a method may include providing a data microservice; sourcing, by the data microservice, data from a data source; formatting the data into tabular data; storing the tabular data in random access memory; exposing, via an endpoint of the data microservice, the tabular data; providing a view microservice, wherein the view microservice formats received data in a predefined format; requesting, by the view microservice, the tabular data from the data microservice; formatting, by the view microservice, the tabular data in the predefined format; and exposing, by the view microservice and as an endpoint of the view microservice, the tabular data formatted in the predefined format.

### BACKGROUND

### 1. Field of the Invention

Embodiments are generally related to systems and methods for data aggregation and post processing using microservices.

### 2. Description of the Related Art

Generating views of dynamic data (e.g., streaming data) can be resource intensive. Dynamic data, by definition, changes over time. In the case of streaming data, these changes can be extensive even over short time periods. Receiving updated views of aggregated and formatted data from various dynamic data sources using conventional means requires repeating resource extensive processes each time the data is updated. These resource intensive processes include gathering, joining, formatting and displaying of the relevant data every time the data is updated.

### SUMMARY

In some aspects, the techniques described herein relate to a method for data aggregation and post processing using microservices including: providing a data microservice; sourcing, by the data microservice, data from a data source; formatting the data into tabular data; storing the tabular data in random access memory; exposing, via an endpoint of the data microservice, the tabular data; providing a view microservice, wherein the view microservice formats received data in a predefined format; requesting, by the view microservice, the tabular data from the data microservice; formatting, by the view microservice, the tabular data in the predefined format; and exposing, by the view microservice and as an endpoint of the view microservice, the tabular data formatted in the predefined format.

In some aspects, the techniques described herein relate to a method, including publishing, by the data microservice, a delta-update event, wherein, when triggered, the delta-update event sends a delta change message that includes a data update to the tabular data;

In some aspects, the techniques described herein relate to a method, including subscribing, by the view microservice, to the delta update event published by the data microservice.

In some aspects, the techniques described herein relate to a method, including receiving, by the view microservice, the delta change message.

In some aspects, the techniques described herein relate to a method, including applying, by the view microservice, the data update to the tabular data.

In some aspects, the techniques described herein relate to a method, including sending, to a user interface, the tabular data in the predefined format.

In some aspects, the techniques described herein relate to a method, including displaying, at the user interface and via a digital display, the tabular data in the predefined format.

In some aspects, the techniques described herein relate to a method, including sending the tabular data to a consuming application.

In some aspects, the techniques described herein relate to a method, wherein the consuming application is an accounting application.

In some aspects, the techniques described herein relate to a method, wherein the data source is a streaming data source.

In some aspects, the techniques described herein relate to a method, wherein the delta change message includes coordinates of the tabular data indicating the location of the data update to the tabular data.

In some aspects, the techniques described herein relate to a method, wherein the delta update event is triggered by additional data from the data source.

In some aspects, the techniques described herein relate to a method, wherein the view microservice requests the tabular data from the data microservice via an API call to the endpoint of the data microservice.

In some aspects, the techniques described herein relate to a system for data aggregation and post processing using microservices including: a data microservice, wherein the data microservice: sources data from a data source; formats the data into tabular data; stores the tabular data in random access memory; and exposes, via an endpoint of the data microservice, the tabular data; and a view microservice, wherein the view microservice formats received data in a predefined format, and wherein the view microservice: requests the tabular data from the data microservice; formats the tabular data in a predefined format; and exposes, as an endpoint of the view microservice, the tabular data formatted in the predefined format.

In some aspects, the techniques described herein relate to a system, wherein the data microservice publishes a delta-update event, wherein, when triggered, the delta-update event sends a delta change message that includes a data update to the tabular data;

In some aspects, the techniques described herein relate to a system, wherein the view microservice subscribes to the delta update event published by the data microservice.

In some aspects, the techniques described herein relate to a system, wherein the view microservice receives the delta change message.

In some aspects, the techniques described herein relate to a system, wherein the view microservice applies the data update to the tabular data.

In some aspects, the techniques described herein relate to a system, wherein the view microservice sends the tabular data in the predefined format to a user interface.

In some aspects, the techniques described herein relate to a system, wherein the user interface displays the tabular data in the predefined format via a digital display.

In some aspects, the techniques described herein relate to a system, wherein the view microservice sends the tabular data in the predefined format to a consuming application.

In some aspects, the techniques described herein relate to a system, wherein the view microservice requests the tabular data from the data microservice via an API call to the endpoint of the data microservice.

### BRIEF DESCRIPTION OF THE DRAWINGS

FIG. 1 is a block diagram of a system for formatting and presenting data using microsystems, in accordance with embodiments.

FIG. 2 shows a logical flow for formatting and presenting data using microsystems, in accordance with embodiments.

### DETAILED DESCRIPTION OF EMBODIMENTS

Embodiments are generally related to systems and methods for data aggregation and post processing using microservices. Embodiments include a standardized approach to defining data services and view services, the interface between them and the use of delta updates to reduce latency in data view creation and offers a scalable and flexible cross-business solution for dynamic data management.

Frameworks disclosed herein define a standardized microservice approach for data services and view services. Each microservice may publish data in a consistent tabular format which can be subscribed to by other services or by end users via, e.g., a user interface (IU). At the point of subscription an end user may pass in additional meta data describing a formatting action to be carried out on relevant data prior to consumption. Examples of formatting actions include joining, aggregation, pivoting, filtering, etc. In accordance with embodiments, data sent to a subscribing end user may include an initial snapshot followed by delta updates for only rows in the tabular output which have changed. The use of delta updates allows the underlying services to only update view rows where one of the constituent data values has changed.

As used herein, the terms “data services” and “view services” refer to programmatic services structured as microservices and that execute in a microservices architecture. Microservices are generally characterized as a collection of loosely coupled, event-driven services. Each service in a microservice architecture is generally concentrated on performing a specific task. Such a narrow focus allows the microservice to be loosely coupled to other services and programs, thereby reducing dependencies, and allowing the use of lightweight technology-agnostic protocols such as HTTP. Microservices are generally relatively small independent programs as compared to layers within a monolithic application. This allows for rapid and autonomous development by small teams.

Microservice interfaces are generally treated as public application programming interfaces (APIs), and often reflect one of two forms of communication: the request-response model, and the event/subscription model.

In request-response communication, one service may invoke another service through an API call. The API call is generally in the form of a call by the calling service to a method exposed by another service. The exposed method may require parameters. That is, the exposed method may expect certain data to be passed in the method call. The exposed method may further, or alternatively, return certain data to the caller as a response to the call. Alternatively, the called method may simply return an acknowledgement to the calling service. The method call may be made using any compatible protocol, but lightweight protocols, such as hypertext transport protocol (HTTP), are well-suited for use with microservices. Methods exposed by a microservice API are commonly referred to as (and referred to herein as) “endpoints”.

In the event/subscription model (also known as event-based communication), a publishing microservice may publish an event. That is, the publishing service may be configured to send a message to subscribing services when a predefined event takes place. When a subscribing service receives notification that the event has taken place, the subscribing service can take some action, such as updating business entities, triggering additional events, etc.

Event/subscription communication may be achieved with the use of an event bus. An event bus allows event-based communication between microservices without requiring that the component microservices be explicitly aware of each other. In an event bus architecture, the publishing microservice can publish an event to the event bus and the event bus can distribute the event to the subscriber microservices. The event bus architecture allows anonymity between microservices while using event/subscription communication. Embodiments herein, however, may also use direct communication of event notification between publishing and subscribing services, or any other architecture that allows for event-based communication between services.

In accordance with embodiments, a data microservice may collect and publish data which forms part of a tabulated data view, and view microservices may format and/or combine tabulated data from multiple data services to create a customized view of the tabulated data. Additionally, multiple view services may serve as data services when compiling a larger composite view of data collected at data services. That is, a view service may expose an endpoint that returns tabulated data. The data may be formatted, filtered, etc., according to the exposing service's configuration. The returned, tabulated, formatted data may be used as input for the requesting view service, and the requesting view service may further format, filter, etc., the returned data. For example, a view of data summarizing risk across multiple regions, or lines of business (LOB), may be obtained by using each region's, or LOB's, risk view output as an input data service.

In addition to view creation and presentation other services may be offered, such as at-source authentication, authorization, and serialization.

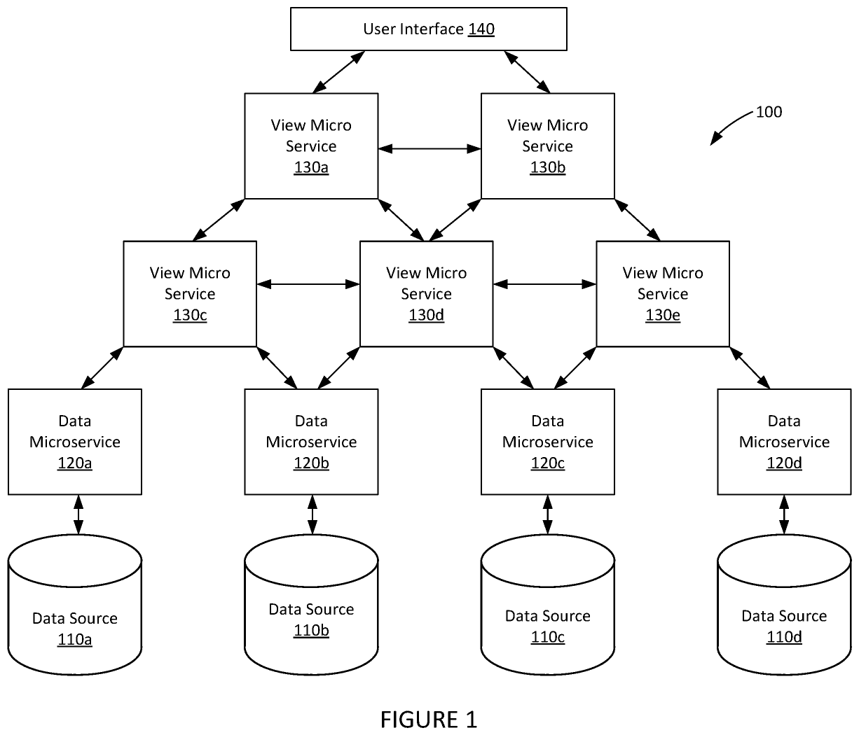

FIG. 1 is a block diagram of a system for formatting and presenting data using microsystems, in accordance with embodiments. FIG. 1 depicts system 100, which includes data source 110a, data source 110b, data source 110c, and data source 110d. These data sources represent different data sources, which can be both internal and external to an organization. Data sources 110a-d may be any relevant data source, such as traditional relational databases, streaming data sources, etc. For example, data source 110a and data source 110b may represent data sources of streaming data, while data sources 110c and 110d represent other data sources.

Streaming data, as used herein, refers to data that is continuously generated. Exemplary streaming data includes data from performance-monitoring sensors in equipment, ‘ticker-tape” data such as stock market updates, real-time data such as stock trades, etc. A streaming data source may take the form of a third-party subscription service, where a subscription fee is paid for access to the data stream.

In accordance with embodiments, microservices configured as data services may be configured to interface with a corresponding data source and accept data from the data source. The interface may be any acceptable method of interfacing with the data source such as via an API, or a database connection protocol such as Open DataBase Connectivity (ODBC), Java® DataBase Connectivity (JDBC), etc. In the case of streaming data, exemplary streaming data protocols include the gRPC protocol or Apache Arrow's® streaming IPC protocol.

In accordance with embodiments, a data service may be configured to receive data from a data source, format the data into a tabular format, and hold the tabular-formatted data in random access memory (RAM) to facilitate rapid updates. The data service may be configured to poll the data source periodically or may establish persistent communication with the data source to enable high volumes of updates in the case of, e.g., a streaming data source.

Additionally, data services may be configured to publish events that other microservice can subscribe to and expose endpoints that other microservices can call. In accordance with embodiments, a data service may expose an endpoint that returns a snapshot of the in-memory tabulated data to the caller. Further, a data service may publish a change event that alerts a subscribing service to an update to the tabular data maintained by the data service. The event message may also contain the data update, such that subscribing services may not only receive a notification but can also receive and implement the changed data.

With continued reference to FIG. 1, included is data microservice 120a, data microservice 120b, data microservice 120c, and data microservice 120d. Data microservices 120a-d are configured to interface with a respective data source. Data microservices 120a-d are shown interfaced with data sources 110a-d, respectively. In accordance with embodiments, data microservices 120a-d are configured to request data from data sources 110a-d, respectively, and to receive a data payload from the respective data source. Each of data services 120a-d then formats the received data into a tabular format and stores the resulting data tables in RAM.

In accordance with embodiments, view microservices may be configured to interface with data microservices, request the tabular data stored by the data service, and further format the received data. View services may interface with one or multiple data microservices and subscribe to events published by these microservices. Exemplary view services include microservices configured to join, filter, pivot, etc., the data received from data microservices.

In accordance with embodiments, a data service may expose an endpoint that accepts, as a passed parameter, a SQL (or similar) statement. After processing the statement, the data service may return only the data from the in-memory table(s) that is requested by the received statement (as opposed to the entire table or set of tables, as the case may be). Correspondingly, view services may pass SQL (or similar) statements as parameters when calling a data service endpoint to request particular data from a data service. For instance, a view microservice may interface with a data microservice and send an initial SELECT statement to the data service. The initial select statement may specify tables, rows, columns, etc., to return to the view service.

Once the view service receives the data specified in the initial select statement, the view service may arrange the data in a tabular format defined by the view service's configuration and make that view of the data available via an endpoint of the view service. Moreover, a view service may publish its own change event, such that, if a notification of a change is received from a data service, and the change affects the in-memory data maintained by the view service, the view service can make the delta change to its maintained data, and trigger and send its own change notification to subscribers of its change event.

In addition to select statements, view services may send (e.g., to a data service) or use other SQL-style statements. For example, a view service may use a JOIN statement to join two tables retrieved from a data microservice with which the view service interfaces. In embodiments, a view service may be configured to interface with multiple data services and may use a JOIN (or similar) statement to join tables from different data microservices.

In accordance with embodiments, a view service may be configured to filter data or to produce a pivot table based on various sets of data. That is, a view service may be configured to request data from one or more data services (which may be either a first level data service that receives data directly from a data source, or a view service that receives data from a data service or another view service, formats the data according to its configuration, and exposes the formatted data via an endpoint of the microservice), and formulate a pivot table view based on dynamic user input or pre-defined groupings, aggregations, etc. Similarly, a view service may request data from one or more data sources, apply a filter to the received data, and expose a filtered view of the requested/received data.

Turning back to FIG. 1, data microservices 120a-d are configured to receive initial requests for data and to publish events that other microservices may subscribe to. In accordance with embodiments, FIG. 1, depicts view microservice 130a, view microservice 130b, view microservice 130c, view microservice 130d, and view microservice 130e. View microservices 130c-d are interfaced directly with data microservices 120a-d. Notably, view microservices 130c-d are shown interfaced to multiple data microservices. View microservice 130c is interfaced with data microservice 120a and data microservice 120b; view microservice 130d is interfaced with data microservice 120b and data microservice 120c; and view microservice 130e is interfaced with data microservice 120c and data microservice 120d.

While the view services depicted in FIG. 1 show limited interface connections with both data services and other view services, this disclosure contemplates that relevant microservices are not limited to any number of interface connections, and may interface with and subscribe to any number of other microservices that is necessary or desired to carry out the functionality described herein.

View microservice 130a and view microservice 130b of FIG. 1 are interfaced to other view services (namely, view services 130c-e). View microservices 130a-b are interfaced with view microservices 130c-e as data services. That is, view services 130c and 130d are acting as a data services to view microservice 130a, and view services 130d and 130e are acting as a data services to view microservice 130b.

In an exemplary embodiment, view microservice 130c may send each of data microservice 120a and data microservice 120b a SELECT statement via an exposed endpoint, may receive the respective data requested from data microservice 120a and data microservice 120b, and may join the two respective data sets as a single data set and publish the single data set as a joined view. View microservice 130a may, in turn, interface with view microservice 130c and request the joined data set exposed via an endpoint by view microservice 130c. In this case, view microservice 130c acts as both a view service by requesting, formatting, and publishing data from various data services, but also acts as a data service, itself, to view microservice 130a by supplying its aggregated and otherwise formatted data combination (which it requested from data microservice 120a and data microservice 120b) to view microservice 130a for further aggregation and/or formatting.

FIG. 1 additionally includes user interface 140. User interface 140 may be used by end users of system 100 to configure, and to view data exposed as endpoints by, view services. For example, an end user of system 100 may use interface 140 to view the data exposed by view microservice 130a and/or view microservice 130b. User interface 140 may also be used to provide any configuration parameters to view services. In an exemplary embodiment, if view microservice 130a is configured to offer a pivoted view of data published by two or more other view services, user interface 140 may provide functionality to an end user to specify, e.g., via an endpoint call including configuration parameters, how the aggregated data should be arranged to produce the desired pivot table. The parameters required by the endpoint call may be supplied by the end user via interface 140 through, e.g., textual input by the end user.

In accordance with embodiments, data services and view services may publish change events which subscriber services may subscribe to. That is, a view service that has requested an initial dataset from one or more data services can subscribe to change publications published by the one or more data services. These change publications may include an indication that data has changed and may further provide only a delta change in the data service's underlying data. The change event may further include the individual row/table/etc., that changed. Such delta change events are highly efficient, since only a small amount of data (the delta change) must be updated in the view service, and full SELECT, JOIN, and other processor and memory intensive processes are avoided. Further, any calculations, aggregations, filters, etc., performed by the view service need not be reperformed unless the delta change data is involved. The efficiencies noted with respect to delta updates, above, are particularly beneficial when the underlying data source is a streaming data source, since streaming data, by definition, is continuously being generated.

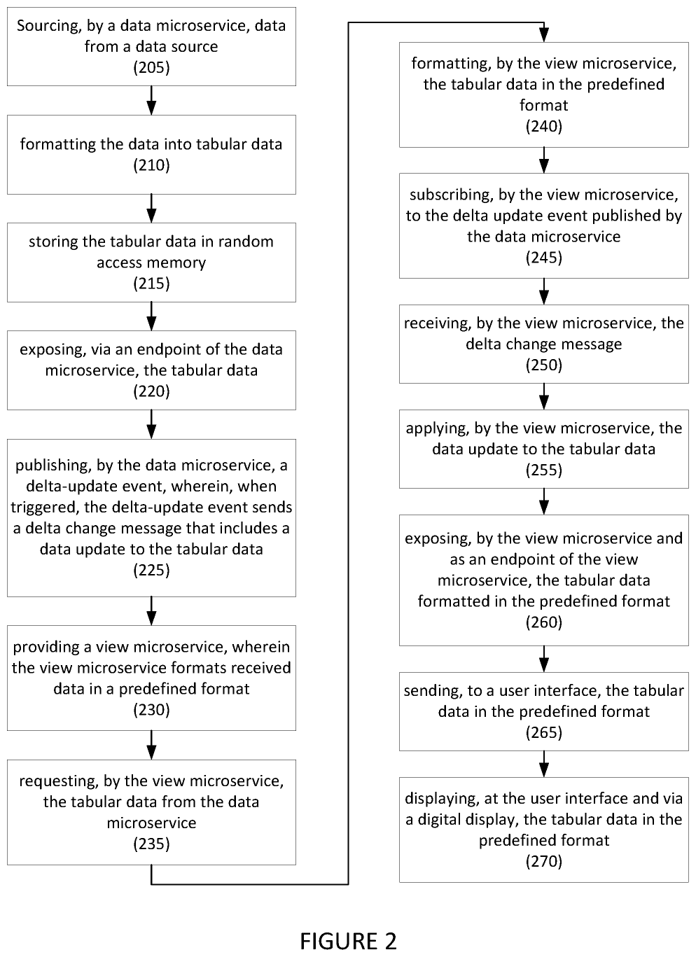

FIG. 2 shows a logical flow for formatting and presenting data using microsystems, in accordance with embodiments.

At step 205, data is sourced by a data microservice from a data source. At step 210 the data microservice formats the data into tabular data. At step 215, the tabular data is stored in random access memory. At step 220, the tabular data is exposed via an endpoint of the data microservice. At step 225, the data microservice publishes a delta-update event, wherein, when triggered, the delta-update event sends a delta change message that includes a data update to the tabular data.

With continued reference to FIG. 2, at step 230, a view microservice is provided. The view microservice formats received data in a predefined format (e.g., by aggregating, joining, filtering, pivoting, etc., requested tabular data). At step 235, the view microservice requests the tabular data from the data microservice. At step 240, the view microservice formats the tabular data in the predefined format. At step 245, the view microservice subscribes to the delta update event published by the data microservice.

Continuing to reference FIG. 2, at step 250, the view microservice receives a delta change message from the published event of the data microservice. At step 255, the view microservice applies the data update to the tabular data. At step 260, the view microservice exposes, as an endpoint of the view microservice, the tabular data formatted in the predefined format. At step 265, the tabular data formatted in the predefined format is sent, in response to an endpoint call from a user interface, to the user interface. And, at step 270, the tabular data formatted in the predefined format is displayed at the user interface.

In accordance with embodiments, the view microservice may send the tabular data formatted in the predefined format to a consuming application in response to an endpoint call from the consuming application. For instance, the view microservice may receive a request for the tabular data from an accounting application that may use the tabular data for accounting purposes. Likewise, a consuming application may be configured to subscribe to a change event published by a view (or data) microservice, and may receive a delta change message in the manner described above.

The various processing steps and/or data flows depicted in the figures and described in greater detail herein may be accomplished using some or all of the system components described also described herein. In some implementations, the described may be performed in different sequences and various steps may be omitted. Additional steps may be performed along with some or all of the steps shown in the depicted flow diagrams. Some steps may be performed simultaneously. Accordingly, the logical flows illustrated in the figures and described in greater detail herein) are meant be exemplary and, as such, should not be viewed as limiting. These logical flows may be implemented in the form of executable instructions stored on a machine-readable storage medium and/or in the form of electronic circuitry.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method comprising:
providing a data microservice;
sourcing, by the data microservice, data from a data source;
formatting the data into tabular data;
storing the tabular data in random access memory;
exposing, via an endpoint of the data microservice, the tabular data;
providing a view microservice, wherein the view microservice formats received data in a predefined format;
requesting, by the view microservice, the tabular data from the data microservice;
formatting, by the view microservice, the tabular data in the predefined format; and
exposing, by the view microservice and as an endpoint of the view microservice, the tabular data formatted in the predefined format.

2. The method of claim 1, comprising publishing, by the data microservice, a delta-update event, wherein, when triggered, the delta-update event sends a delta change message that includes a data update to the tabular data.

3. The method of claim 2, comprising subscribing, by the view microservice, to the delta update event published by the data microservice.

4. The method of claim 3, comprising receiving, by the view microservice, the delta change message.

5. The method of claim 4, comprising applying, by the view microservice, the data update to the tabular data.

6. The method of claim 5, comprising sending, to a user interface, the tabular data in the predefined format.

7. The method of claim 6, comprising displaying, at the user interface and via a digital display, the tabular data in the predefined format.

8. The method of claim 4, comprising sending the tabular data to a consuming application.

9. The method of claim 8, wherein the consuming application is an accounting application.

10. The method of claim 1, wherein the data source is a streaming data source.

11. The method of claim 2, wherein the delta change message includes coordinates of the tabular data indicating a location of the data update to the tabular data.

12. The method of claim 2, wherein the delta update event is triggered by additional data from the data source.

13. The method of claim 1, wherein the view microservice requests the tabular data from the data microservice via an API call to the endpoint of the data microservice.

14. A system comprising:
a data microservice, wherein the data microservice:
sources data from a data source;
formats the data into tabular data;
stores the tabular data in random access memory; and
exposes, via an endpoint of the data microservice, the tabular data; and
a view microservice, wherein the view microservice formats received data in a predefined format, and wherein the view microservice:
requests the tabular data from the data microservice;
formats the tabular data in a predefined format; and
exposes, as an endpoint of the view microservice, the tabular data formatted in the predefined format.

15. The system of claim 14, wherein the data microservice publishes a delta-update event, wherein, when triggered, the delta-update event sends a delta change message that includes a data update to the tabular data.

16. The system of claim 15, wherein the view microservice subscribes to the delta update event published by the data microservice.

17. The system of claim 16, wherein the view microservice receives the delta change message.

18. The system of claim 17, wherein the view microservice applies the data update to the tabular data.

19. The system of claim 18, wherein the view microservice sends the tabular data in the predefined format to a user interface.

20. The system of claim 14, wherein the view microservice requests the tabular data from the data microservice via an API call to the endpoint of the data microservice.
